(19) United States
(12) Patent Application Publication
(10) Pub. No.: US 2015/0345373 A1
(43) Pub. Date: Dec. 3, 2015

(54) COMPRESSING DEVICE WITH THERMAL PROTECTION

(71) Applicant: VALEO AIR MANAGEMENT UK LIMITED, Redditch Worcestershire (GB)

(72) Inventor: Stephen Michael Knight, Basildon, Essex (GB)

(73) Assignee: Valeo Air Management UK Limited, Redditch, Worcestershire (GB)

(21) Appl. No.: 14/652,533

(22) PCT Filed: Dec. 12, 2013
(86) PCT No.: PCT/GB2013/053278

§ 371 Date: Jun. 16, 2015

(30) Foreign Application Priority Data
Dec. 17, 2012 (GB) 1222704.7

(51) Int. Cl. F02B 37/04; F02B 33/40

(52) U.S. Cl. CPC F02B 37/04; F02B 33/40

(57) ABSTRACT

An apparatus for supplying an internal combustion engine with a compressed air charge is disclosed. The apparatus includes a first compressing device, for example a turbocharger, and a second compressing device, for example an electric supercharger. The second compressing device is downstream of the first compressing device. A part, for example the bearing assembly, of the second compressing device is thermally shielded from the heat of the compressed air charge by a labyrinth seal.

### TECHNICAL FIELD

The present invention relates to compressing devices such as superchargers, and to apparatus comprising two compressing devices for supplying an engine with a compressed air charge.

### BACKGROUND OF THE INVENTION

As a result of the desire to reduce carbon dioxide emissions from internal combustion (IC) engines, there is a tendency towards smaller (i.e. reduced capacity) engines. In order to maintain acceptable levels of power output, it has been suggested that a turbocharger be fitted to these smaller engines. Whilst the turbocharger may increase the maximum power output of the engine, it has been found to cause unacceptable levels of turbo-lag, often making the engine impractical in automotive applications. Installing a supercharger upstream or downstream of the turbocharger (i.e. between the turbocharger and the engine) has been suggested as a way of reducing this problem of excessive turbo lag. However, in such an arrangement, the downstream compressing device is subjected to especially high temperatures because it receives hot input gases from the upstream compressing device. This can damage the downstream compressing device and/or restrict the type/design of device that can be used in such an arrangement.

### SUMMARY OF THE INVENTION

According to a first aspect of the invention there is provided an apparatus for supplying an internal combustion engine with a compressed air charge, the apparatus comprising a first compressing device and a second compressing device, the second compressing device being downstream of the first compressing device and being arranged to compress the output of the first compressing device into the compressed air charge,

wherein a part of the second compressing device is thermally shielded from the heat of the compressed air charge by a labyrinth seal. The present invention recognises that a labyrinth seal can be used as a thermal shield to protect heat-sensitive parts of the compressing device; this is especially beneficial when two compressing devices are to be used in series. The second compressor device comprises the labyrinth seal.

Labyrinth seals tend to allow a degree of fluid flow through them, and thus provide imperfect fluid sealing. The labyrinth seal is preferably arranged such that fluid received into a first (upstream) side of the labyrinth seal is at a first temperature and fluid leaving the opposing (downstream) side of the labyrinth seal is at a second temperature, the second temperature being lower than the first. The labyrinth seal is preferably a non-contact seal; it is therefore especially attractive for high rotational speed applications (such as turbo or superchargers).

The second compressing device may comprise a compressor element for compressing the output of the first compressing device into the compressed air charge. A compressor element is typically arranged such that, when driven, it draws in intake air, compresses the intake air and outputs a compressed charge. The compressor element is preferably rotatable. The compressor element may be a compressor wheel. It will be appreciated that the compressor element need not necessarily be a single piece any may comprise a plurality of sub-elements.

The second compressing device may comprise a bearing assembly for supporting rotation of the compressor element. Bearing assemblies have been found to be particularly susceptible to damage caused by high temperatures. Accordingly, the part of the second compressing device thermally shielded by the labyrinth seal preferably comprises the bearing assembly.

The second compressing device may comprise a drive assembly for driving the compressor element. The drive assembly may be an electric drive assembly. The second compressing device may comprise a seal arranged such that the drive assembly is sealed from the compressed air charge. Providing such a seal has been found to protect the drive assembly from the output of the upstream compressing device (for example oil, corrosive gases from the exhaust gas recirculation system, particulates and humidity carried in the compressed air charge), and therefore better enables the second compressing device to be used downstream of a first compressing device. The seal is preferably arranged such that the pressure in the drive assembly is independent of the pressure of the compressed air charge. The part of the second compressing device thermally shielded by the labyrinth seal may comprise the seal.

The seal is preferably a face seal. The seal is preferably a gas-lubricated face seal. Gas-lubricated face seals are known per se. An example of a gas-lubricated face seal is sold by Freudenberg Sealing Technologies.

The second compressing device may be a supercharger, and more preferably an electric supercharger. The present invention is thought to be especially useful for electric superchargers, which may comprise components that are especially susceptible to excessive temperatures. The first compressing device may be a turbocharger.

The labyrinth seal preferably comprises a stationary part interlocking with a movable part to define a labyrinth therebetween. The movable part may be associated with the compressor element such that the movable part is rotatable relative to the stationary part. The moveable part may be associated with (for example integral with) the rear face of the compressor element. The compressor element is preferably a compressor wheel. The rear of the compressor wheel may interlock with a stationary part (for example a housing of the compressing device) to define a labyrinth therebetween.

The labyrinth seal preferably extends in a radial direction (i.e. fluid travels though it in a generally radial direction). The radially outermost side of the labyrinth seal is preferably exposed to the compressed charge.

The labyrinth seal may be arranged such that the temperature of the compressed charge on the downstream side is 150 DegC. or lower. The temperature of the compressed charge on the downstream side may be at least 30 Deg C. below the temperature on the upstream side.

According to a second aspect of the invention there is provided a compressing device for supplying an internal combustion engine with a compressed air charge, wherein the compressing device comprises a labyrinth seal arranged to thermally shield part of the compressing device from the heat of the compressed charge. The compressing device is preferably a supercharger, and more preferably an electric supercharger.

According to yet another aspect of the invention there is provided an internal combustion engine in combination with the apparatus described herein. The engine is preferably for use in an automobile. The engine is preferably a relatively small capacity engines. The engine is preferably 4 litres or less, more preferably 3 litres or less, and yet more preferably 2 litres or less). The engine may be in an automobile. The automobile may be less than 5 tonnes, more preferably less than 3.5 tonnes, and more preferably less than 2 tonnes.

It will be appreciated that any features described with reference to one aspect of the invention are equally applicable to any other aspect of the invention, and vice versa. For example any features described with reference to the first aspect of the invention are equally applicable to the second aspect of the invention.

### DESCRIPTION OF THE DRAWINGS

Embodiments of the invention will now be described, by way of example only, with reference to the accompanying schematic drawings of which:

FIG. 1 is a schematic showing an engine incorporating an apparatus according to a first embodiment of the invention;

FIG. 2 is a sectional perspective view of the supercharger in the first embodiment of the invention; and

FIG. 3 is a sectional perspective view of a supercharger in a second embodiment of the invention.

### DETAILED DESCRIPTION

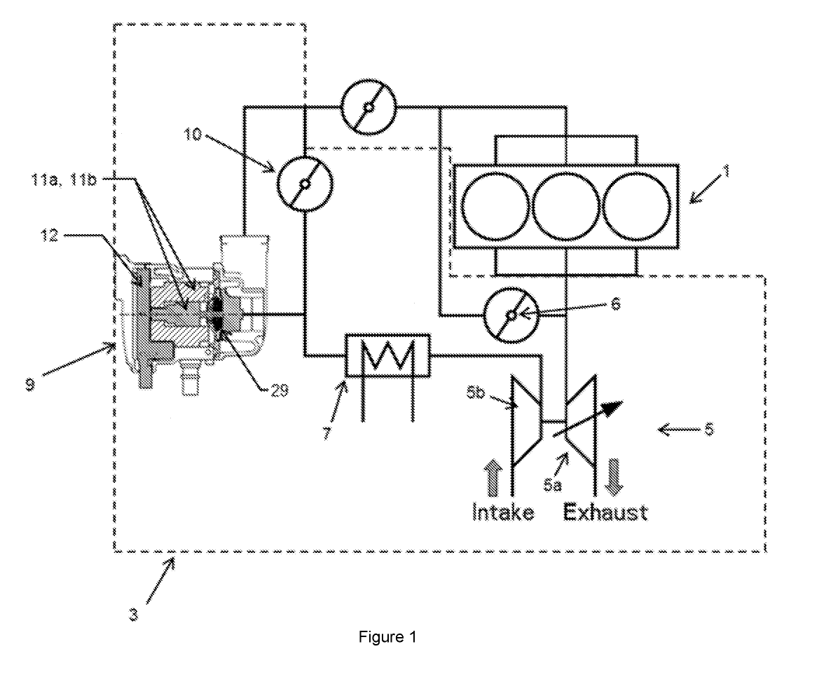

FIG. 1 shows a three-cylinder internal combustion (IC) engine 1 in combination with an apparatus 3 for supplying compressed intake gases (i.e. a compressed air charge) in accordance with a first embodiment of the invention. The apparatus 3 (marked by a dotted line) comprises a turbocharger 5, an exhaust gas recirculation (EGR) valve 6, a charge air cooler (CAC) 7, a supercharger 9 and a supercharger bypass valve 10.

In accordance with conventional turbochargers, the turbocharger 5 is driven by the exhaust gases from the engine 1 passing through the Variable-Nozzle Turbine (VNT) 5a thereby driving the turbocharger compressor 5b. Some of the exhaust gas output of the engine 1 is returned as an input to the engine via the EGR valve 6.

The output of the turbocharger 5 is then fed through the CAC 7 before being supplied to the supercharger 9. The supercharger 9 further compresses the output of the turbocharger and supplies the compressed intake gases (referred to herein as a compressed air charge) to the engine 1.

In the first embodiment of the invention, the supercharger 9 is an electric supercharger. Electric superchargers have been found to reduce the fuel consumption and emissions of an engine in comparison to conventional (direct engine-driven) superchargers. They are therefore attractive in applications in which the fuel consumption and/or the carbon dioxide output of the engine are looking to be improved. However, electric superchargers have previously been dismissed for use downstream of a turbocharger because the electric supercharger would suffer from the corrosive effect of the particulates and oil-air mix that are typically output from the turbocharger as well as the EGR gas. Electric superchargers were also thought to be susceptible to damage caused by the high temperature of the compressed charge. In particular, when exposed to temperatures above 150 DegC, at least the bearings have been found to deteriorate or fail.

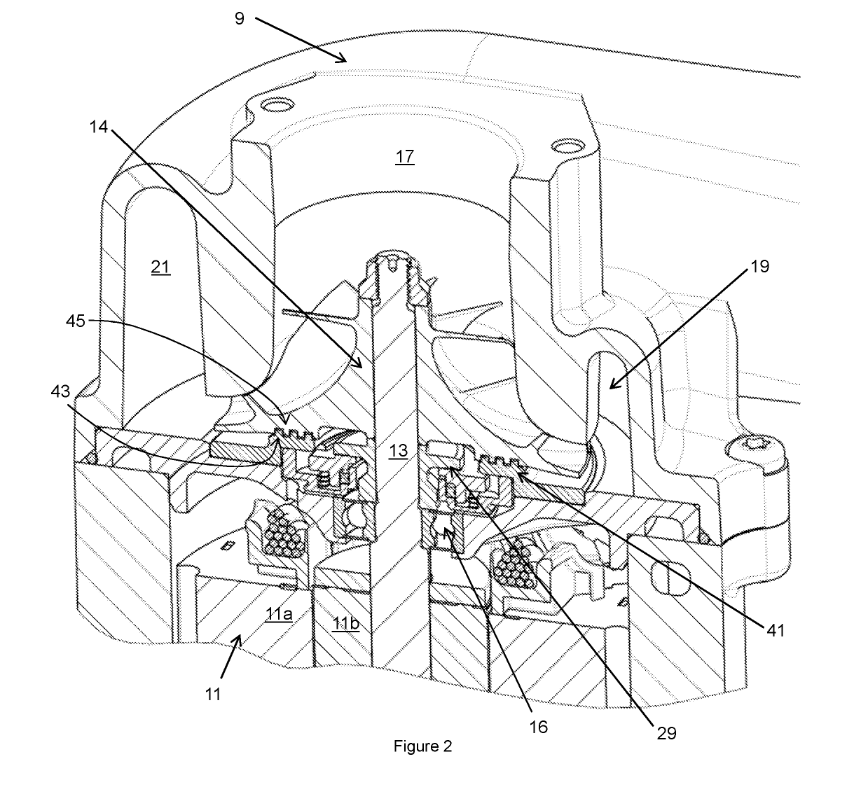

FIG. 2 is a sectional perspective view of the electric supercharger 9 in the first embodiment of the invention. The electric supercharger 9 includes an electric drive assembly having a motor 11 (comprising a stator 11a and rotor 11b), and a control unit in the form of a Printed circuit Board (PCB) (not visible in FIG. 2) located to the rear of the motor. Power to the electric motor 11 and control unit is supplied by a lead/acid battery (not shown) charged by an alternator (not shown) associated with the engine 1. The drive assembly is arranged to drive the compressor wheel 14 via the shaft 13. The shaft 13 is supported by a front bearing assembly 16 and a rear bearing assembly (not visible in FIG. 2).

In common with known superchargers, the supercharger 9 receives air through the inlet 17. The compressor wheel 14 then compresses the inlet air and expels it into the radial chamber 19. Whilst most of the compressed charge passes through the outlet 21, some of the compressed charge leaks back under the compressor wheel 14.

According to the first embodiment of the invention the supercharger comprises a six-stage labyrinth seal 41. The labyrinth seal 41 comprises a lower stationary part 43 having three raised concentric rings. The rings on this lower part 43 interlock with three corresponding, radially offset, rings formed in an upper part 45 that is integral to the rear of the compressor wheel 14. The upper and lower parts 43, 45 do not touch each other and instead define a tortuous path (the labyrinth) between the parts. The present invention recognises that a labyrinth seal 41 can be used as a thermal shield to protect heat-sensitive parts of the supercharger.

In the first embodiment, the radially outermost side of the labyrinth seal 14 is exposed to the compressed charge at a temperature of around 180 DegC. Some of the compressed charge passes through the labyrinth seal 14 and leaves on the radially innermost side. During this process some of the heat in the compressed charge is dissipated and the temperature on the inner (downstream) side of the labyrinth seal is around 140 DegC. This temperature is low enough to prevent damage or wear to the upper bearing assembly 16 and the face seal 29 (see below). The labyrinth seal is thus arranged to thermally shield parts of the supercharger from the heat of the compressed charge. This enables two compressing devices to be used in series to supply the IC engine.

The supercharger 9 of the first embodiment comprises a face seal 29 located behind the compressor 14 and arranged such that the drive assembly 11 is sealed from the compressed air charge. The seal 29 is a gas-lubricated face seal which forms a circumferential seal around the shaft 13 whilst still allowing rotation of the shaft at high rotational speeds (for example up to 80,000 rpm). The face seal 29 is arranged to prevent ingress of the compressed air charge into the electric drive assembly such that the pressure in the drive assembly is independent of the pressure of the compressed charge. The face seal has been found to be especially beneficial when used in an electric supercharger downstream of a turbocharger. The labyrinth seal 14 is arranged to shield the face seal 29 from the full temperature of the compressed charge and therefore reduce heat-induced damage to the seal.

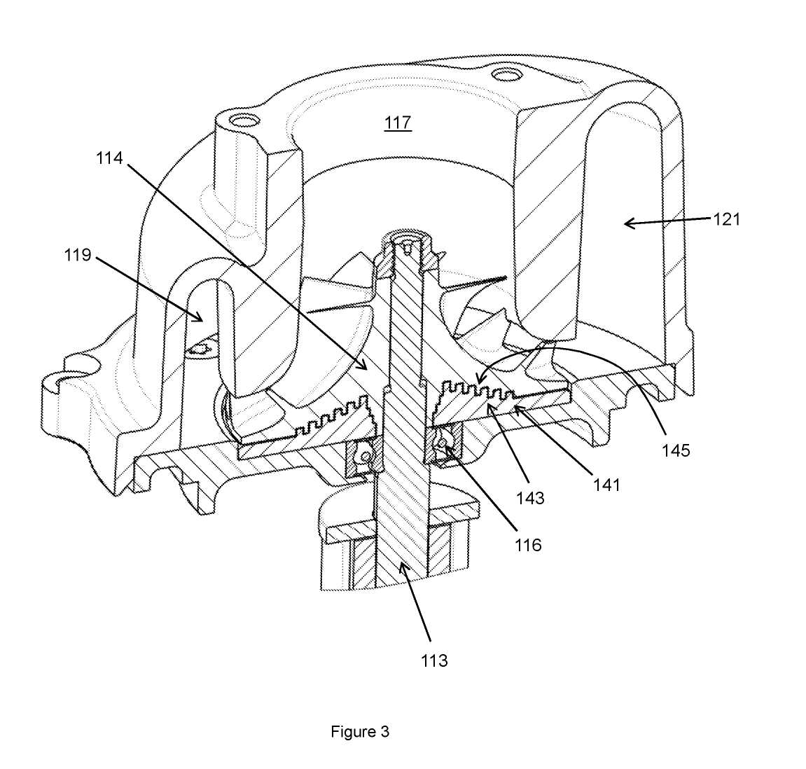

FIG. 3 shows the upper portion of a supercharger according to a second embodiment of the invention. Features in the second embodiment of the invention that correspond to similar features in the first embodiment of the invention, are shown with the same reference numerals as in the first embodiment, but with the addition of the prefix ‘1’ (or ‘10’ where appropriate).

The supercharger 109 of the second embodiment comprises a 15 stage labyrinth seal 141, formed by interlocking concentric rings. Unlike the first embodiment, the rings are located on an inclined slope (increasing in height towards the centre of the labyrinth seal). The supercharger 109 of the second embodiment does not comprise a face seal. Instead the labyrinth seal provide a thermal shield for the bearing assembly 116 and the drive assembly (not shown) downstream of the bearing assembly 116.

The supercharger 109 of the second embodiment is part of a similar apparatus to that shown in FIG. 1, except that the intercooler is instead located downstream of the supercharger (and the turbocharger); this means that the compressed charge is especially hot and the thermal shielding afforded by the labyrinth seal is especially important.

Whilst the present invention has been described and illustrated with reference to particular embodiments, it will be appreciated by those of ordinary skill in the art that the invention lends itself to many different variations not specifically illustrated herein. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. An apparatus for supplying an internal combustion engine with a compressed air charge, the apparatus comprising:
a first compressing device; and
a second compressing device, the second compressing device being downstream of the first compressing device and being arranged to compress the output of the first compressing device into the compressed air charge,
wherein a part of the second compressing device is thermally shielded from the heat of the compressed air charge by a labyrinth seal.

2. The apparatus according to claim 1, the second compressing device comprising
a compressor element for compressing the output of the first compressing device into the compressed air charge, and
a bearing assembly for supporting rotation of the compressor element,
wherein the part of the second compressing device thermally shielded by the labyrinth seal comprises the bearing assembly.

3. The apparatus according to claim 2, the second compressing device further comprising:
a drive assembly for driving the compressor element; and
a seal arranged such that the drive assembly is sealed from the compressed air charge,
wherein the part of the second compressing device thermally shielded by the labyrinth seal comprises the seal.

4. The apparatus according to claim 1, wherein the second compressing device is an electric supercharger.

5. The apparatus according to claim 1, wherein the first compressing device is a turbocharger.

6. The apparatus according to claim 1, wherein the labyrinth seal comprises a stationary part interlocking with a movable part to define a labyrinth therebetween, the movable part being associated with the compressor element such that the movable part is rotatable relative to the stationary part.

7. The apparatus according to claim 6, wherein the compressor element is a compressor wheel and the moving part is associated with the rear of the compressor wheel.

8. The apparatus according to claim 1, wherein the labyrinth seal is a radial labyrinth seal, the radially outermost side of the labyrinth seal being exposed to the compressed charge.

9. An electric supercharger for supplying an internal combustion engine with a compressed air charge, wherein the supercharger comprises a labyrinth seal arranged to thermally shield part of the supercharger from the heat of the compressed charge.

10. An internal combustion engine in combination with the apparatus of claim 1.

11. (canceled)
